(19) United States
(12) Patent Application Publication
(10) Pub. No.: US 2020/0025637 A1
(43) Pub. Date: Jan. 23, 2020

(54) HUB FOR A BICYCLE WHEEL ALLOWING THE DETERMINATION OF THE DRIVING TORQUE AND OF THE POWER GENERATED BY THE CYCLIST

(71) Applicant: COMMISSARIAT A L'ENERGIE ATOMIQUE ET AUX ENERGIES ALTERNATIVES, Paris (FR)

(72) Inventors: Florian PORTE, Grenoble Cedex 09 (FR); Thomas Dupont, Loriol-sur-Drome (FR); Pierre-Jean Martin, Loriol-sur-Drome (FR)

(73) Assignee: COMMISSARIAT A L'ENERGIE ATOMIQUE ET AUX ENERGIES ALTERNATIVES, Paris (FR)

(21) Appl. No.: 16/514,079

(22) Filed: Jul. 17, 2019

(30) Foreign Application Priority Data
Jul. 20, 2018 (FR) 18 56775

(51) Int. Cl. G01L 5/13; B60B 27/02; B60B 27/04; B60B 1/04

(52) U.S. Cl. CPC G01L 5/13; B60B 1/041; B60B 27/047; B60B 27/023

(57) ABSTRACT

Hub for a bicycle wheel allowing the determination of the driving torque of a bicycle wheel, comprising a torque lateral flange intended for the fastening of transmission spokes transmitting the torque of the wheel hub to the rim, strain gauges and/or pairs of strain gauges arranged on the torque lateral flange in the vicinity of at least certain attachment points of the spokes, said strain gauges being configured to deliver signals making it possible to determine the driving torque of the wheel.

### TECHNICAL FIELD AND PRIOR ART

The present invention relates to a hub for a bicycle wheel allowing the determination of the driving torque of said wheel and of the drive power generated by the cyclist and to a method for determining said driving torque and said drive power.

The measurements of the driving torque and of the drive power of a bicycle wheel make it possible to evaluate the performance of a cyclist, for example during his training.

The drive power can be obtained from measurements on the pedal. However in this case transmission losses are not taken into account.

The drive power can also be obtained from measurements on the hub of the drive wheel, generally the rear wheel.

Document FR3001290 describes a hub for determining torque comprising a central body mounted to rotate freely about a central shaft defining the axis of rotation, and two lateral flanges for the fastening of the spokes. Strain gauges are mounted on the central body which is used as a test body. The hub described in this document does not make it possible to evaluate the influence of the forces that are not useful for the propulsion of the bicycle, such as the weight of the cyclist and the inclination of the bicycle.

It is sought to improve the reliability of the determining of this drive power.

### DISCLOSURE OF THE INVENTION

It is consequently a purpose of the present invention to offer a hub for a bicycle wheel that makes it possible to reliably determine the drive torque and the drive power generated by the cyclist.

The purpose announced hereinabove is achieved by a hub for a bicycle wheel comprising a central body intended to be mounted to rotate freely about a central shaft, lateral flanges intended for the fastening of one end of the wheel spokes, among which a torque lateral flange intended for the fastening of at least one portion of the spokes transmitting the torque from the hub to the rim, and strain gauges arranged on the torque lateral flange on zones where the forces applied to the spokes would be concentrated, for example in the vicinity of at least certain attachment points of the spokes.

The inventor realised that in placing strain gauges in these zones, signals were obtained that had a sensitivity to the tangent force that corresponded to the propulsion force of the cyclist and of the sensitivities to the parasitic forces that do not participate in the propulsion, such as the frontal force due to the weight of the cyclist and the lateral force due to the rocking movement during pedalling, and that each one of these sensitivities could be characterised independently, for example on a test bench so as to establish an algorithm that makes it possible to extract the value of these forces using all of the measurements coming from the gauges, in order to then reliably determine the drive torque and therefore the drive power.

Furthermore, the measurements obtained by this instrumented wheel hub very advantageously make it possible to detect if the spokes have the same tension or not and to correct this tension where applicable.

In addition these measurements also make it possible to distinguish the different pedalling gestures of the cyclist, for example if the cyclist pedals while sitting, if he pedals in standing position, if he is standing up on the pedals or he it in free wheel for example.

The instrumented wheel hub according to the invention therefore allows for a very fine monitoring of the performance of the cyclist, which can be very useful during training.

The instrumented hub according to the invention is a relatively simple realisation, since it comprises strain gauges fastened onto the flange, for example glued.

Preferably, the gauges are arranged as close as possible to the attachment points of the spokes, which makes it possible to obtain signals that are not polluted by other mechanical forces applied to the hub, such as those generated by the pawls of the pawl free wheel present in the hub.

The subject-matter of the present invention then is a hub for a bicycle wheel allowing the determination of the driving torque of a bicycle wheel, comprising a longitudinal axis, a central body intended to be mounted to rotate freely about a central shaft, the longitudinal axis being intended to be coaxial to the central shaft, lateral flanges intended for the fastening of an end of wheel spokes, among which a torque lateral flange intended for the fastening of at least one portion of the transmission spokes transmitting the torque from the hub to the rim, strain gauges and/or pairs of strain gauges mounted on the torque lateral flange in zones where the forces applied to the spokes are concentrated, said strain gauges being arranged in such a way as to deliver signals making it possible to determine the driving torque of the wheel.

In another embodiment, each gauge is arranged on a zone of the torque lateral flange that are subjected at a given instant to a traction or a compression. Each strain gauge can be arranged in a plane substantially parallel to the longitudinal axis of the hub.

For example, the gauges are angularly distributed regularly on the torque lateral flange about the longitudinal axis of the hub and/or the strain gauges and/or pairs of strain gauges are arranged on a radially external zone of the lateral transmission flange.

The present invention also has for object a system for determining the driving power of a bicycle wheel comprising a hub of a bicycle wheel according to the invention, and means for determining the angular speed of the body of the hub with respect to the central shaft.

The system for determining can comprise a microcontroller to which are connected the gauges, said microcontroller communicating with a computer with a wireless connection.

The present invention also has for object a bicycle wheel comprising a hub of a bicycle wheel according to the invention or a system for determining according to the invention, a rim, at least transmission spokes of which one end is attached to the torque lateral flange and another end is fastened to the rim.

The transmission spokes can advantageously comprise means for adjusting their tension.

Another subject-matter is a bicycle comprising a frame, a first wheel and a second wheel, the second wheel being a wheel according to the invention, a pedal driving said second wheel and an on-board computer (communicating with the microcontroller and displaying information on the driving power of the cyclist determined from signals emitted by the gauges.

Another subject-matter is a method for determining the driving torque implementing a hub according to the invention, comprises:

a) the collecting of signals from the strain gauges,

b) the determining of the driving torque using signals from the strain gauges and of a relationship connecting the signals of the gauges and a first sensitivity of each strain gauge or pair of strain gauges to a tangent force resulting from the driving torque according to the angular position of the hub, a second sensitivity of each strain gauge or pair of strain gauges to a front force resulting from the weight of the cyclist according to the angular position of the hub, and a third sensitivity of each strain gauge or pair of strain gauges to a lateral force resulting from the inclination of the hub according to the angular position of the hub,

For example, the angle of inclination of the wheel and the angular speed of the wheel are determined by means of an accelerometer and a gyrometer, in the step b), the traction torque C_{T} at least is determined.

The present invention also has for object a method for determining the driving power comprising the determining of the driving torque by implementing the method according to the invention, and the calculating of the product of the angular speed of the wheel and of the driving torque.

The present invention also has for object a method for monitoring the state of the transmission spoke tension of a wheel according to the invention, comprising the steps

collecting signals from gauges or pairs of gauges,

comparing said signals,

if the difference between the value of at least one signal and the values of the other signals is greater than a given threshold, a tension differential in at least one transmission spoke in respect is diagnosed,

determining of the at least one transmission spoke having a tension differential with respect to the others,

modifying the tension of said at least one transmission spoke,

verifying the tension of the transmission spokes.

The verification can be done using a vibration sensor, such as a microphone or by comparing the signals from the gauges or pairs of gauges.

### BRIEF DESCRIPTION OF THE DRAWINGS

The present invention shall be better understood based on the following description and the accompanying drawings wherein:

FIG. 1 diagrammatically shows a bicycle that can comprise a hub according to the invention,

FIG. 2 is a perspective view of a hub of prior art,

FIG. 3A is a front view of an example of a hub according to the invention,

FIG. 3B shows a half bridge of gauges that can be implemented in the present invention,

FIG. 3C is a front view of a bicycle wheel comprising a hub according to another example of the invention,

FIG. 4 is a front view of another example of a hub according to the invention,

FIG. 5 is a front view of another example of a hub according to the invention,

FIG. 6 is a front view of another example of a hub according to the invention,

FIGS. 7A to 7D diagrammatically show a wheel illustrating the tangent force, the frontal force, the lateral force and the inclination of the wheel respectively,

FIG. 8 is a graphical representation of the signals of the gauges of the hub of FIG. 3C,

FIG. 9 is a graphical representation of the drive torque as a function of the tension measured by a reference sensor,

FIG. 10 is a graphical representation of the relative sensitivity with respect to the reference sensor of the gauges in mV/mV to the tangent force in four different angular positions of the hub,

FIG. 11 is a graphical representation of the sensitivity of the gauges in mV/Bars to the frontal force as a function of the angular position of the hub,

FIG. 12 is a graphical representation of the signals in mV of the gauges of the hub of FIG. 3C as a function of the time in the case of a wheel mounted on a bicycle as a free wheel.

FIG. 13 is a graphical representation of the sensitivity of the gauges in mV/Bars to the lateral force according to the angular position of the hub,

FIG. 14 is a graphical representation of the sum S=J1+J2+J3+J4 for a tangent force applied along 4 different angular positions,

FIG. 15 is a graphical representation of the sums J1+J2+J3+J4 and J1+J3−J2−J4 over time,

FIGS. 16 and 17 are graphical representations of the signals emitted by an accelerometer and a gyrometer and that can be used in the present invention,

FIGS. 18 and 19 are is a graphical representations of the instantaneous drive power calculated thanks to the second method for determining,

FIG. 20 is a graphical representation of sound spectra of a wheel spoke.

### DETAILED DISCLOSURE OF PARTICULAR EMBODIMENTS

The present invention shall be described mainly for a two-wheel bicycle, but the invention applies to a wheel hub that can equip any type of bicycle, for example with one wheel or with three wheels or more. Furthermore, the hub according to the invention can be applied to bicycles that are propelled solely by the energy of the cyclist and also to bicycles with assisted propulsion, for example electrically.

In FIG. 1, an example can be seen of a two-wheeled bicycle that can implement the hub according to the invention.

The cycle comprises a steered wheel 2 and a drive wheel 4. The drive wheel 4 is generally arranged at the rear in relation to the position of the cyclist. The drive wheel 4 comprises a hub 6 mounted to rotate freely on a rotating shaft 9. The hub 6 comprises at least one pinion 8.

The cycle comprises a pedal 10 provided with at least one pinion 12 which drives the pinion 8 carried by a hub 6 by the intermediary of a chain 14.

The drive wheel comprises a rim 16 connected to the hub 6 by spokes. The rim 16 generally carries a tyre 20.

At least a portion of the spokes is used to transmit the torque of the hub 6 to the rim 16.

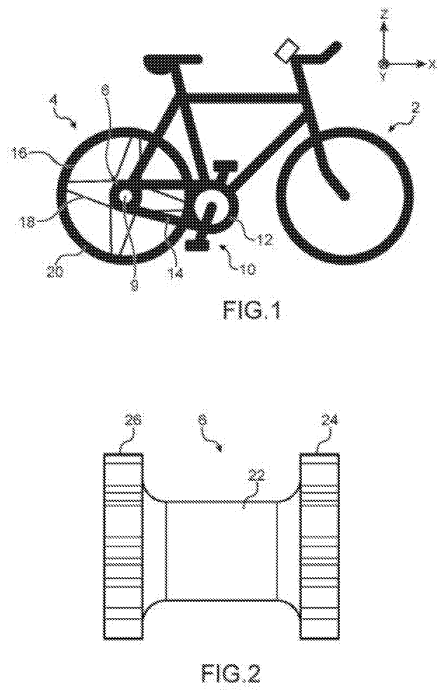

In FIG. 2, it is possible to see an example of a hub 6. It comprises a central body 22 mounted freely about the rotating shaft 9 and two lateral flanges 24, 26.

For example, a lateral flange 24, referred to as torque lateral flange, is used for the fastening of the spokes transmitting the torque from the hub to the rim and a lateral flange 26, referred to as lateral centring flange, is used for the fastening of the spokes providing the centring of the hub with respect to the rim. The spokes 18 are designated as “transmission spokes”.

Generally the centring spokes are oriented radially from the hub towards the rim and the transmission spokes of the torque 18 are inclined with respect to the radial direction.

The tension of the spokes can be adjusted. For this a nut, called a spoke head, is provided at an end of the spoke, either on the rim side, or on the hub side. By turning this nut in one direction or the other, the tension of the spoke is modified. It is sought to have the same tension on each spoke.

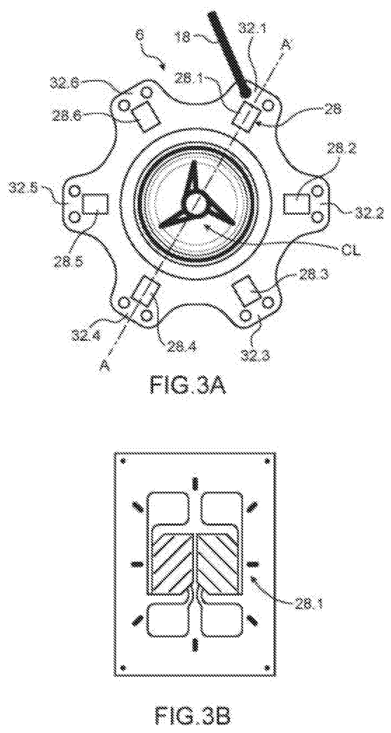

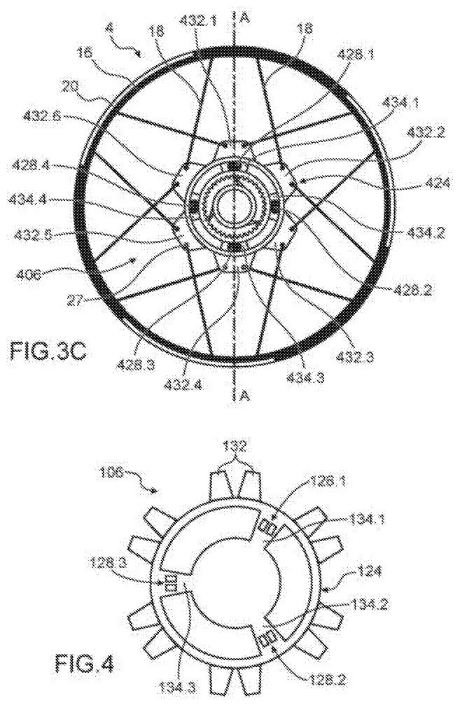

In FIG. 3A, an example can be seen of a hub according to the invention.

The invention applies to the hub transmitting the torque to the rim, it shall be designated as “engine hub”.

According to the invention, the engine hub 6 comprises a measuring system comprising devices for measuring strain 28 arranged in the vicinity of the fastening points of the transmission spokes 18. The devices for measuring strain 28 comprise one or several strain gauges fastened, for example glued, on the torque lateral flange 24. The torque lateral flange 24 on which are fastened the gauges forms a test body that translates a force or a torque into a mechanical strain, which is measured by a variation in the electrical resistance of the gauge or gauges. The test body and the gauges form a member sensitive to the drive force but also to the forces that are not useful in the propulsion of the bicycle. Thanks to this sensitive member, it is possible to isolate the drive force and to calculate the driving torque and therefore the drive power. The strain gauges are arranged on the torque flange at the locations where the forces applied to the spokes are concentrated.

In the example shown, the strain gauges are arranged in the vicinity of the attachment points of the spokes to the torque lateral flange. Preferably, the strain gauges are arranged at a distance between 1 mm and 2 cm of attachment points.

Alternatively, the torque lateral flange is configured to localise the concentration of the forces applied to the spokes in different zones of the attachment points, for example by thinning the portions of the torque flange that carry the attachment points.

In FIG. 3A, the torque lateral flange 24 comprises an outer ring 32 provided with six lugs 32.1 to 36.6, each lug comprises two fastening points of two transmission spokes 18. In this example, the lugs are angularly distributed regularly.

The spokes 18 extend symmetrically from a lug in the direction of the rim, with respect to a radial axis AA.

In this example, the devices for measuring strain 28 are arranged in zones that are subjected to both a traction and a compression. The devices for measuring strain 28 each comprise a pair of gauges mounted as a Wheatstone half bridge. Each one of the gauges is sensitive to the extension and to the compression, with the mounting as a half bridge making it possible to add these two effects.

Pairs of gauges 28.1 to 28.6 are placed on the lugs 32.1 to 32.6 respectively.

In FIG. 3B, an example can be seen of a pair of strain gauges 28.1 mounted as a half bridge.

The gauges are placed as close as possible to the attachment points on the hub. This arrangement advantageously makes it possible to avoid the influence of the strains due to the pawl mechanism CL generally arranged in the hub.

In the example of a hub shown in FIG. 3A, advantageously the gauges are fastened directly on the lugs as close as possible to the attachment points.

A mechanical reinforcement can advantageously be provided to distribute the load of the pawls over the periphery of the hub.

Alternatively, the system for measuring comprises as many pairs of gauges as lugs, even as many pairs of gauges as spokes.

The orientation of the gauges can advantageously be determined by modelling the forces generated by the spokes on the various zones of the torque lateral flange so as to determine which zones undergo an extension and which zones undergo a compression.

In FIG. 4, another example can be seen of the hub 16 comprising a torque lateral flange 124 comprising three tabs 134.1 to 134.3 that connect the central portion of the flange to the outer ring. In this example, the measuring means can comprise three pairs of strain gauges 128.1, 128.2 and 128.3 each one mounted on a tab and arranged radially. Alternatively, a pair of gauges is mounted on each lug 132.

In FIG. 5, another example can be seen of the hub according to the invention. The attachments of the spokes 18 are such that the spokes 18 extend in a direction that is quasi-tangential to a circle centred on the axis of rotation. The spokes are fastened in pairs to lugs 232 with the two attachment points being arranged radially. The zone located between the two attachment points undergoes only an extension or a compression when a force is applied, a single gauge 228 can then be implemented.

The gauges are arranged on the lug between the two attachment points.

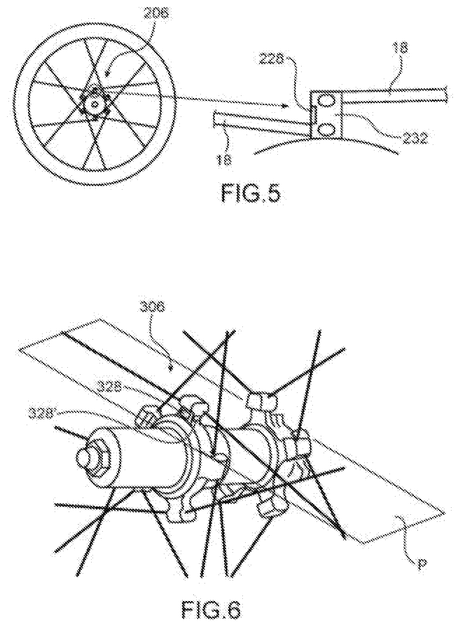

In FIG. 6, it is possible to see yet another example of a hub wherein the spokes are practically in the same plane P, the gauges are mounted on the lug oriented perpendicular to this plane P. In this example, the gauges can be arranged either in the plane of the hub, in this case the zone also undergoes a traction and a compression, a pair of gauges 328 is then implemented, or in a plane orthogonal to the plane of the hub, in this case the zone undergoes only an extension or a compression, a single gauge 328′ is implemented.

It will be understood that the arrangement and the number of gauges depend on the geometry of the hub and the configuration of the attachment points in relation to one another. Preferably, at least three gauges or pairs of gauges as a Wheatstone half bridge are implemented, preferably distributed angularly regularly about the axis of the hub.

The gauges are preferably piezoresistive gauges because they are more suited to low frequencies, and the signal processing is faster and the results are more precise with respect to those of piezoelectric gauges, however the implementing of piezoelectric gauges can be considered.

The gauges are connected to an analogue/digital converter that converts the variation in voltages at the terminals of the half bridges, optionally integrated to a microcontroller UC. The microcontroller UC provides the processing of the digital signals, such as described hereinbelow. The microcontroller is carried by an electronic card. Preferably the card has the same shape as the flange in such a way as to be placed against the latter so as to reduce the size as well as to facilitate the connection between the card and the gauges. The gauges and the microcontroller are powered by a battery for example assembled on the electronic card. The electronic card communicates advantageously with an on-board computer, designated as C, that can be fastened to the handlebars of the bicycle (FIG. 1). The on-board computer is advantageously provided with a screen in such a way as to display the performance in real time or to record it for post-processing. The electronic card can communicate with a fixed computer of the PC type which makes it possible to monitor and to process the performance of the cyclist remotely more preferably via wireless transmission. For this it is equipped with a transmission antenna. For example the signal is transmitted according to the Bluetooth® or ANT standard and via radio waves.

Several methods for determining the drive power supplied by the cyclist using the instrumented hub according to the invention shall now be described.

Prior to the implementation of a method for determining the drive power generated by the cyclist, a step of calibration is carried out. The calibration parameters obtained are recorded in the microcontroller.

Preferably, the existence of an imbalance in the tension of the spokes is verified and it is corrected. This step more preferably takes placed on a factory bench.

Very advantageously, the hub according to the invention makes it possible to detect this imbalance in the tension of the spokes and then to correct it. This step of balancing the tensions of the spokes is more preferably carried out before the hub is used in order to optimise the flatness of the wheel and to prevent an error in the determining of the driving torque. The threshold as a percentage beyond which it is considered that there is an imbalance can be configured, it is for example of about 10%.

Indeed, reading the signals of the gauges makes it possible to detect an imbalance in the tension of the spokes when the wheel is not subjected to any force, i.e. when the bicycle is stopped and the cyclist is not on the bicycle. For example, if the signal from one of the gauges shows a significant deviation with respect to the other signals, this can mean an imbalance in the tensions of the spokes.

After this step of detecting, the adjusting of the tension of the spokes can be carried out by tuning the vibration frequency of the spokes when they are stressed by an impact, using a vibratory analysis, of the Fourier transform type or based on the principle of a guitar tuner. The resonance frequency is measured with a vibration sensor, such as for example a piezoresistive or piezoelectric microphone. This method allows for a very precise adjustment of the tension of each spoke.

In FIG. 20, it is possible to see the sound spectra in dB obtained by fast Fourier transform according to the frequency in Hz, on the signals from a micro placed on the hub of FIG. 3C or in the vicinity of the wheels, when the bicycle is stopped and is not subjected to any force. Each spectrum corresponds to a different tension of a spoke. It is observed that the main frequencies vary from 320 to 350 Hz according to the tension of the spokes. The frequency is theoretically proportional to the square root of the tension. This method which uses a measuring device other than the gauges makes it possible to adjust the tension of the spokes independently of the sensitivity of the gauges. It can thus make it possible to correct any deviation of the latter.

Alternatively, the adjusting can be carried out by directly using the signals supplied by the gauges instead of making use of a vibration sensor.

The adjusting of the tension of the spokes is obtained by manipulating the nuts at the end of the spokes by means of a suitable tool, such as pliers or a spanner.

A “Reset” step can advantageously be carried out before the bicycle is used in order to compensate for the differences in sensitivities of the gauges due to the variation in tension of the spokes without having to adjust the latter or in order to compensate for a variation in the sensitivities once the tension of the spokes has been adjusted, by applying a corrective coefficient to the values coming from the calibration on a bench, recorded in the microcontroller. This adjusting makes it possible to substantially reduce, and even suppress, a parasitic effect on one or several signals emitted by the gauges. Advantageously the “factory” parameters can be restored if requested by the user.

Each one of these signals supplied by the gauges depends on:

the motor torque or driving torque, applied to the wheel by the “effective” force of the cyclist, i.e. the force tangent to the wheel, which makes it possible to have the bicycle move forward; all the gauges regardless of the angular position are sensitive to this tangent force,

“parasitic” forces applied to the wheel: the frontal forces resulting from the weight of the cyclist, and on the lateral forces resulting from the rocking movement of the bicycle during pedalling;

the sensitivity of the half bridges of gauges which depends, for the parasitic forces, on the location where the force is applied, i.e. on the angular position of the wheel.

the tension of the spokes.

The step of calibrating comprises the determining of the functions f_{Li} and f_{Fi} which model the sensitivities of each half bridge 28.1, 28.2, 28.3, 28.4 to the lateral force and to the frontal force respectively according to the angular position. J₁, J₂, J₃, J₄ are the signals or measurements of the half bridges 28.1, 28.2, 28.3, 28.4 respectively.

For example the functions f_{Li} and f_{Fi} can be determined by applying a processing of the signal implementing techniques that will make it possible to extract information from the signal by taking account of the periodicity thereof. Well-known methods can be applied, such as breakdown into Fourier series of the signals coming from the gauges:

$${signal}_{gauge} \to \frac{{a}_{0}}{2} + {\sum }_{n = 1}^{∞} ( {a}_{n} cos n θ + {b}_{n} sin n θ ) .$$

By taking account of the effect of the weight of the cyclist P, of the inclination φ and of the torque C_{T}, the equation consists in calculating the matrix H defined by:

$$[ \begin{matrix}{J}_{1} \\ {J}_{2} \\ {J}_{3} \\ {J}_{4}\end{matrix} ] = H * [ \begin{matrix}{C}_{T} \\ P \\ θ \\ ϕ\end{matrix} ]$$

The matrix H can be developed in the following way:

$$[ \begin{matrix}{J}_{1} \\ {J}_{2} \\ {J}_{3} \\ {J}_{4}\end{matrix} ] = \begin{matrix}{C}_{T} * {S ( θ )}_{J 1} + P * ( {f}_{L 1} ( θ ) Sin ( ϕ ) + ( {f}_{F 1} ( θ ) ) \\ {C}_{T} * {S ( θ )}_{J 2} + P * ( {f}_{L 2} ( θ ) Sin ( ϕ ) + ( {f}_{F 2} ( θ ) ) \\ {C}_{T} * {S ( θ )}_{J 3} + P * ( {f}_{L 3} ( θ ) Sin ( ϕ ) + ( {f}_{F 3} ( θ ) ) \\ {C}_{T} * {S ( θ )}_{J 4} + P * ( {f}_{L 4} ( θ ) Sin ( ϕ ) + ( {f}_{F 4} ( θ ) )\end{matrix}$$

with:

S(θ)_{Ji}, the respective sensitivities of the gauges to the tangent force, with Σᵢ₌₁ⁿS(θ)_{Ji}=1

f_{Li} and f_{Fi}, the sensitivities of the bridges to the lateral and frontal forces respectively according to the angular position of the wheel.

The sensitivities f_{Li}, f_{Fi} and S(θ)_{Ji} are obtained from signals of the gauge half bridges on a bench in particular conditions in which either a lateral force, or only a frontal force is applied to the wheel.

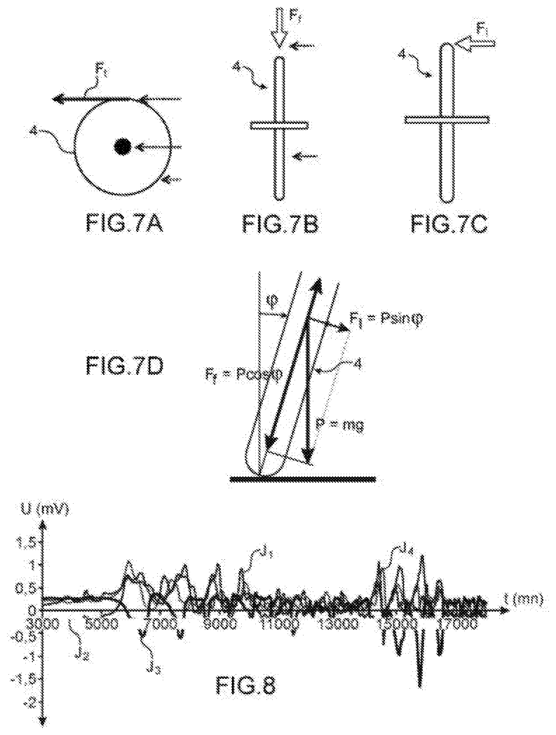

FIG. 7A diagrams the tangent force Fₜ on the wheel. FIG. 7B diagrams the front force F_{f} on the wheel. FIG. 7C diagrams the lateral force F_{f} on the wheel.

In the following example, the sensitivities f_{Li} and f_{Fi} are determined for the hub of FIG. 3C, wherein the hub 406 comprises an outer ring connected to the central body carrying the pinion by four tabs 434.1, 434.2, 434.3, 434.4 angularly distributed regularly.

In this example, the tabs 434.1 and 434.3 are aligned radially with the lugs 432.1 and 432.4 and the tabs 434.2 and 434.4 are aligned radially with the connection zone of the lugs 432.2 and 432.3 and connection zone of the lugs 432.5 and 432.6 respectively. The half bridges 428.1 to 428.4 are mounted on the tabs 432.1 to 432.4 respectively.

In FIG. 8, it is possible to see the voltage signals U in mV of the gauges 28.1 to 28.4 for the hub of FIG. 3C as a function of time t in ms, these signals are representative of the tangent force, the frontal force and the lateral force.

J₁, J₂, J₃, J₄ are the signals or measurements of the half bridges 28.1, 28.2, 28.3, 28.4 respectively. It is to be noted that the inversion of the signal J₃ is solely due to an inverted connection on the half bridge 28.3.

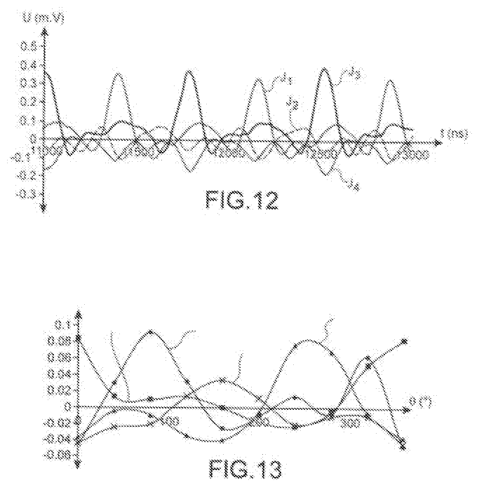

In FIG. 12, it is observed that the signals J₁ and J₃ have close profiles, and that the signals J₂ and J₄ have close profiles.

In order to be able to carry out the signal processing, it is determined beforehand, for example on a measuring bench, the sensitivity of the gauges to the drive torque or tangent force, the sensitivity to the frontal force (weight of the cyclist) and the sensitivity of the lateral force resulting from the back-and-forth movement of the bicycle, according to the angular position of the wheel.

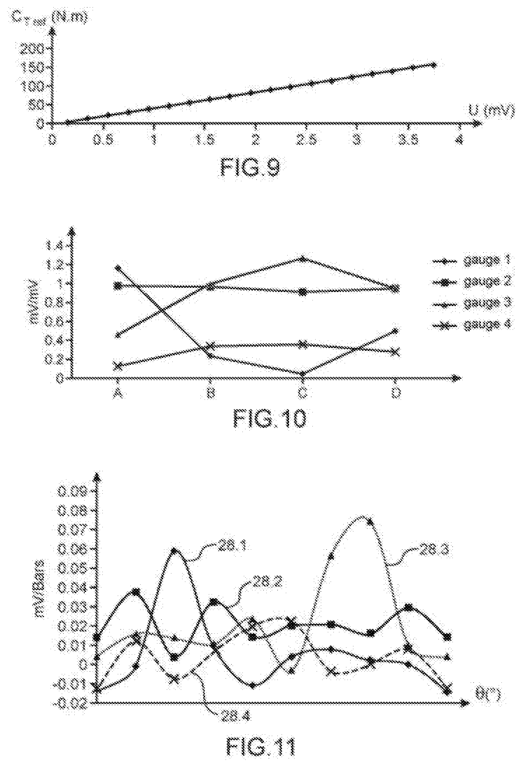

The sensitivity is the ratio between the measurement of a gauge in mV and a reference measurement in mV taken by a reference sensor, which supplies a linear response according to the force applied. The reference sensor is for example a calibrated model manufactured by the company SCAIME®, having very good precision, i.e. >0.03% full scale error, and a measurement range from 0 to 100 kg. In FIG. 9, it is possible to see the characteristic drive torque C_{Tref} in N.m according to the value of the voltage in mV supplied by the reference sensor.

In FIG. 10, it is possible to see the sensitivity of the gauges 28.1 to 28.4 to the tangent force Ft or propulsion force according to the position of the wheel, A, B, C, D designate four positions of the wheel. For this, acquisition is made in the four positions A, B, C, D of the wheel, of the signals delivered by the pairs of gauges on a wheel which is subjected only to a propulsion force, for example mounted on a test bench, and to which is applied a torque. It is not subjected to a frontal force or to a lateral force.

It is observed that this sensitivity is different according to the location of the gauges on the hub. This variation in sensitivity is linked to the hub of FIG. 3C that strongly undergoes the force of the strain of the pawls. In the case of the hub of FIG. 3A, there is no such variation in sensitivity.

In FIG. 11, it is possible to see the sensitivity in mV/Bars of the pairs of gauges 28.1 to 28.4 to the frontal force according to the angular position of the wheel in °. For this, acquisition is made of the signals delivered by the pairs of gauges on a wheel that undergoes only a frontal force F_{f}, for example the wheel is mounted on a test bench and a cylinder exerts a vertical force downwards on the wheel. The sensitivities of the gauges are designated by the reference of the gauges.

The sensitivity of the gauges to the frontal force is periodical, it is therefore possible to model the variation in the sensitivity of the gauges to the frontal force according to the angular position of the wheel, and therefore, at each instant by knowing the angular position of the wheel and the weight of the cyclist, to correct the measurements in order to suppress the effect of the frontal force.

As a comparison in FIG. 12, it is possible to see the signals in mV of the gauges according to the time in ms emitted by the gauge half bridges in the case of a wheel mounted on a bicycle as a free wheel on a flat and smooth terrain without pedalling, which reverts to measuring the frontal force, since the cyclist does not exert any drive force, or any lateral force due to the absence of pedalling. It is observed that the measurements in actual conditions and the measurements on a bench are close, which validates the bench measurements for determining the sensitivity to the frontal force.

In FIG. 13, it is possible to see the sensitivity of the gauges 28.1 to 28.4 to the lateral force according to the angular position θ of the wheel in °. For this, acquisition is made of the signals delivered by the pairs of gauges on a wheel that undergoes only a lateral force, for example the wheel is mounted on a bench and a cylinder exerts a lateral force on the wheel for a given angle. These measurements are obtained for an angle of inclination φ shown in FIG. 7D.

In the example given, the determining of the sensitivities is carried out at a force intensity and angle of inclination φ that are constant. Alternatively, it is possible to vary the intensity of the frontal force, the intensity of the lateral force and the angle of inclination φ.

As for the sensitivity of the frontal force, the sensitivity of the gauges to the lateral force is periodical for a value of the angle of inclination, it is therefore possible to model the variation in the sensitivity of the gauges to the lateral force according to the angular position of the wheel and according to the angle of inclination φ, and therefore, at each instant by knowing the angular position of the wheel and the weight of the cyclist, to correct the measurements in order to suppress the effect of the frontal force. It is to be noted that it is considered that the effect of the weight of the cyclist, when the bicycle is inclined by an angle φ, is equivalent to a force P sin φ applied perpendicularly to the wheel.

In an advantageous example, a temperature sensor can be provided for example integrated into the electronic card, making it possible to correct any influence of the latter.

A first example of the method for determining the drive power shall now be described.

The method for determining the drive power using the instrumented hub comprises the following steps:

Acquisition of signals J₁, J₂, J₃, J₄ emitted by the gauges.

The matrix H obtained during the step of calibration is then inverted,

Using the inverted matrix H⁻¹ and signals J₁, J₂, J₃, J₄, C_{T}, P, φ, θ are calculated.

Processing of the signals in order to extract the portion relative to the drive torque applied to the wheel and making it possible to determine the power generated by the cyclist, and the part relative to the parasite forces.

Calculation of the power generated by the cyclist.

This method has for advantage of not having to implement means for measuring the angular position of the wheel and of the angle of inclination of the wheel.

The functions that represent the sensitivities f_{Li}, f_{Fi} and S(θ)_{Ji} are preferably chosen to be relatively simple, making them compatible with the computational capacities of the microcontroller, for example with an inverse method algorithm.

A hub for determining that comprises as many gauge half bridges or gauges emitting separate signals as unknowns is used to implement the method according to the first example. In the case where the weight of the cyclist is not known, four signals are measured in order to determine C_{T}, P, φ, θ. In the case where the weight of the cyclist is known, three signals are measured in order to measure C_{T}, φ, θ.

As the drive power is the product of C_{T} and of the angular speed, it is then possible to calculate the power generated by the cyclist as a function of time, by calculating the angular speed starting from θ.

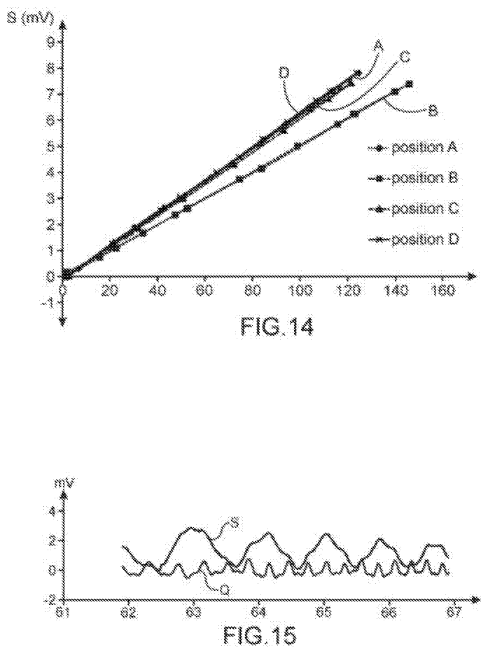

According to a substantially simplified alternative of the method according to the first example, the sum S is taken of the signals J₁, J₂, J₃, J₄ at each angular position, which makes it possible to suppress the effect of the pawls. This sum for each position A; B, C and D is shown in FIG. 14 according to the torque applied in N.m. This method does not take account of the angular position of the wheel, or the inclination of the bicycle.

By comparing the sum S=J₁+J₂+J₃+J₄ and the quantity Q=J₁+J₃−J₂−J₄ over time (on the abscissa the time is given in wheel revolutions—FIG. 15), it is possible to dissociate the part of the tangent force and the part of the force linked to the weight, i.e. the frontal force and the lateral force, in the signals emitted by the gauges. The quantities S and Q are shown in FIG. 15 according to the wheel revolution. In this example φ is zero

At each instant, the four half bridges see the front forces and lateral forces that depend on the angular position of the half bridges.

Thus in the quantity Q, the share of the tangent force is suppressed.

For example, by calculating S−Q/2, a good approximation is obtained of the traction torque C_{T}. The instantaneous power is given by C_{T}×θ′, θ′ being the angular speed. Thus by knowing the angular speed, it is possible to determine the instantaneous power generated by the cyclist.

According to a second example of the process for determining the drive power, the angular speed and the angle of inclination obtained by the data from a gyroscope and/or from an accelerometer are used as shall be described hereinbelow. Furthermore, the weight of the cyclist is generally known. This method has the advantage of reducing the computational volume of the microcontroller and of allowing for a verification via redundancy.

The angular speed can be calculated using the angular position of the wheel which can be obtained, as well as the inclination of the wheel, from the data of a gyroscope and possibly a reference, for example supplied by a magnet on the frame and a magnetometer on the hub, for example the axis gy of a gyroscope directly gives the instantaneous angular speed of the wheel.

Alternatively, the angular position of the wheel and its inclination can be obtained by merging the data of an accelerometer, of a gyroscope and of a magnetometer.

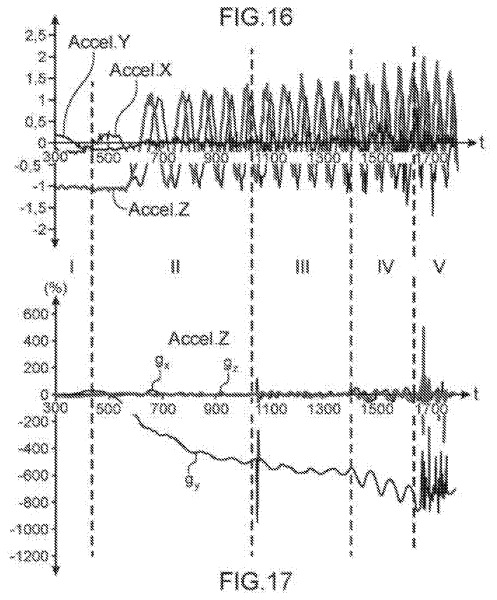

In FIG. 16, it is possible to see the signals in m/s² in the directions X, Y and Z supplied by an accelerometer embedded on the bicycle for three modes of pedalling and a free wheel phase.

The period I corresponds to a cyclist stopped. The period II corresponds to a cyclist performing pedalling in a seated position. The period III corresponds to a cyclist performing pedalling in a standing position. The period IV corresponds to a cyclist standing up on the pedals, and the period V corresponds to a free wheel phase.

Accel X is the acceleration in the direction X.

Accel Y is the acceleration in the direction Y.

Accel Z is the acceleration in the direction Z.

In FIG. 17, it is possible to see the signals in °/s in the directions X, Y and Z supplied by a gyroscope embedded on the bicycle, for the five periods described hereinabove.

gx is the angular speed about the axis X.

gy is the angular speed about the axis Y.

gz is the angular speed about the axis Z.

Using the values of C_{T}, of θ, of P and of φ, it is also possible to determine the different modes of pedalling applied by the cyclist.

Indeed, when C_{T} is zero and θ varies, the cyclist is not pedalling and the bicycle is in free wheel.

In the sitting mode, the weight is supported more on the rear wheel, a maximum value of P is then observed.

In the standing up on the pedals mode, a side-to-side rocking movement therefore a strong variation in φ is observed.

The user can determine the thresholds according to his weight and his gesture.

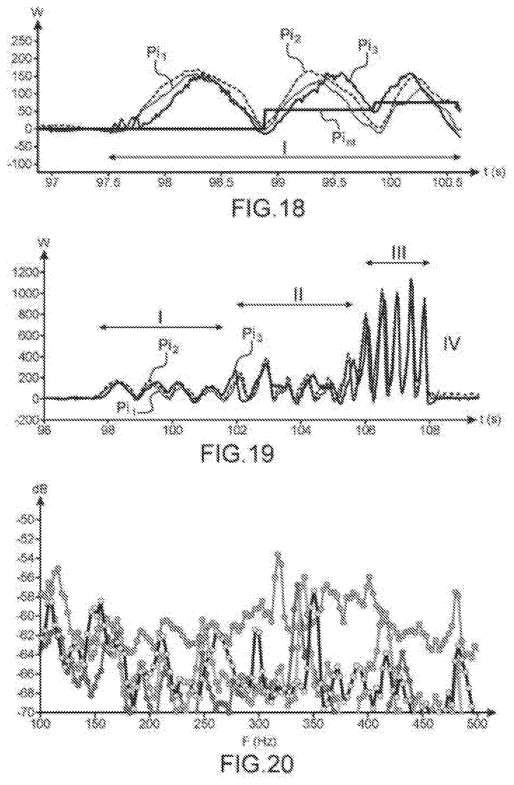

FIG. 18 shows the instantaneous power in W as a function of the time t in s, calculated according to the second method.

Pi1 is the instantaneous power calculated using the signals obtained thanks to the hub according to the invention by calculating the drive torque using the quantity S−Q/2.

Pi2 is the instantaneous power calculated using the signals obtained thanks to the hub according to the invention by calculating the drive torque using the quantity S.

Pi3 is the instantaneous power calculated using a reference measurement taken in the pedals.

Pint is the integral of the power at each pedal stroke, the value read is the power developed during the preceding pedal stroke. Calculating Pint makes it possible to provide for example to the cyclist information on the average power of the preceding pedal stroke that is more comprehensible than the instantaneous power which varies constantly.

The instantaneous power varies in a substantially sinusoidal manner, with each sinusoid corresponding to a pedal stroke: the beginning and the end of each pedal stroke is determined by the passing through a minimum of the value of the drive torque with a value less than 10% of the value of the maximum drive torque.

It is observed, on the one hand, that the instantaneous powers Pi1 and Pi2 obtained thanks to the signals from the hub according to the invention are coherent with the power Pi3 measured at the pedals.

The power Pi2 is greater than the power Pi1, as it integrates all of the parasitic forces.

In FIG. 19, it is possible to see the variation in the instantaneous power over time in seconds over a longer period than FIG. 18 showing different pedalling modes.

As indicated hereinabove, the signals supplied by the gauges can make it possible to distinguish the different pedalling modes.

1. A hub for a bicycle wheel allowing the determination of the driving torque of a bicycle wheel, comprising a longitudinal axis, a central body intended to be mounted to rotate freely about a central shaft, the longitudinal axis being intended to be coaxial to the central shaft, lateral flanges intended for the fastening of an end of wheel spokes, among which a torque lateral flange intended for the fastening of at least one portion of the transmission spokes transmitting the torque from the hub to the rim, strain gauges and/or pairs of strain gauges mounted directly on the torque lateral flange in zones where the forces applied to the spokes are concentrated, said strain gauges being arranged in such a way as to deliver signals making it possible to determine the driving torque of the wheel.

2. The hub for a bicycle wheel according to claim 1, wherein at least the torque lateral flange comprises attachment points of the first ends of the spokes, and wherein the strain gauges and/or pairs of strain gauges are located in the vicinity of at least certain attachment points of the spokes.

3. The hub for a bicycle wheel according to claim 1, wherein the gauges of each pair of strain gauges are mounted as a Wheatstone half bridge, and wherein the pairs of gauges are arranged in zones of the torque lateral flange that are simultaneously subjected to a traction and a compression.

4. The hub for a bicycle wheel according to claim 1, wherein the pairs of strain gauges are mounted on an external face of the torque lateral flange substantially orthogonally to the longitudinal axis of the wheel hub.

5. The hub for a bicycle wheel according to claim 1, wherein each gauge is arranged on a zone of the torque lateral flange that are subjected at a given instant to a traction or a compression.

6. The hub for a bicycle wheel according to claim 1, wherein the torque lateral flange comprises lugs radially protruding outwards, with each lug comprising at least one fastening point of a transmission spoke, with each gauge or pair of gauges being arranged on a lug.

7. The hub for a bicycle wheel according to claim 1, wherein the strain gauges are piezoresistive gauges.

8. The hub for a bicycle wheel according to claim 1, comprising a number of strain gauges and/or pairs of strain gauges in such a way as to supply signals for at least three separate angular positions on the central body of the torque lateral flange.

9. A system for determining the driving power of a bicycle wheel comprising a hub of a bicycle wheel according to claim 1 and means for determining the angular speed of the body of the wheel hub with respect to the central shaft.

10. A bicycle wheel comprising a hub of a bicycle wheel according to claim 1, a rim, at least transmission spokes of which one end is attached to the torque lateral flange and another end is fastened to the rim.

11. A method for determining the driving torque implementing a hub for a bicycle wheel having a hub that includes a longitudinal axis, a central body intended to be mounted to rotate freely about a central shaft, the longitudinal axis being intended to be coaxial to the central shaft, lateral flanges intended for the fastening of an end of wheel spokes, among which a torque lateral flange intended for the fastening of at least one portion of the transmission spokes transmitting the torque from the hub to the rim, strain gauges and/or pairs of strain gauges mounted directly on the torque lateral flange in zones where the forces applied to the spokes are concentrated, said strain gauges being arranged in such a way as to deliver signals making it possible to determine the driving torque of the wheel, a rim, at least transmission spokes of which one end is attached to the torque lateral flange and another end is fastened to the rim, the method comprising:
a) collecting signals from the strain gauges,
b) determining the driving torque from signals from strain gauges and from a relationship determined beforehand connecting the signals of the gauges and a first sensitivity of each strain gauge or pair of strain gauges to a tangent force resulting from the driving torque according to the angular position of the wheel hub, a second sensitivity of each strain gauge or pair of strain gauges to a front force resulting from the weight of the cyclist according to the angular position of the wheel hub, and a third sensitivity of each strain gauge or pair of strain gauges to a lateral force resulting from the inclination of the wheel hub according to the angular position of the wheel hub.

12. The method for determining according to claim 11, comprising, prior to the step a), the step of determining said relationship from the signals supplied by the gauges when the wheel hub is mounted on a measuring bench and/or a step of adjusting tensions of the transmission spokes comprising:
collecting signals from gauges or pairs of gauges,
comparing said signals,
if the difference between the value of at least one signal and the values of the other signals is greater than a given threshold, a tension differential in at least one transmission spoke in respect is diagnosed,
determining of the at least one transmission spoke having a tension differential with respect to the others,
modifying the tension of said at least one transmission spoke,
verifying the tension of the transmission spokes.

13. The method for determining according to claim 11, wherein in the step b) the traction torque C_{T}, the weight P of the cyclist, the inclination ϕ of the wheel carrying the wheel hub and the angular speed θ of the wheel carrying the wheel hub are calculated.

14. The method for determining the driving torque comprising the determining of the driving torque by implementing the method according to claim 11, and the calculating of the product of the angular speed of the wheel and of the driving torque.

15. The method for determining the driving torque according to claim 11, comprising a sub-step of monitoring the state of the transmission tension of a wheel for a bicycle having a hub that includes a longitudinal axis, a central body intended to be mounted to rotate freely about a central shaft, the longitudinal axis being intended to be coaxial to the central shaft, lateral flanges intended for the fastening of an end of wheel spokes, among which a torque lateral flange intended for the fastening of at least one portion of the transmission spokes transmitting the torque from the hub to the rim, strain gauges and/or pairs of strain gauges mounted directly on the torque lateral flange in zones where the forces applied to the spokes are concentrated, said strain gauges being arranged in such a way as to deliver signals making it possible to determine the driving torque of the wheel, a rim, at least transmission spokes of which one end is attached to the torque lateral flange and another end is fastened to the rim, the method comprising the steps:
collecting signals from gauges or pairs of gauges,
comparing said signals,
if the difference between the value of at least one signal and the values of the other signals is greater than a given threshold, a tension differential in at least one transmission spoke in respect is diagnosed,
determining of the at least one transmission spoke having a tension differential with respect to the others,
modifying the tension of said at least one transmission spoke,
verifying the tension of the transmission spokes.

16. The hub for a bicycle wheel according to claim 1, wherein at least the torque lateral flange comprises attachment points of the first ends of the spokes, and wherein the strain gauges and/or pairs of strain gauges are located as close as possible to the attachment points of the spokes.

17. A method for monitoring the state of the transmission spoke tensions of a wheel having a hub that includes a longitudinal axis, a central body intended to be mounted to rotate freely about a central shaft, the longitudinal axis being intended to be coaxial to the central shaft, lateral flanges intended for the fastening of an end of wheel spokes, among which a torque lateral flange intended for the fastening of at least one portion of the transmission spokes transmitting the torque from the hub to the rim, strain gauges and/or pairs of strain gauges mounted directly on the torque lateral flange in zones where the forces applied to the spokes are concentrated, said strain gauges being arranged in such a way as to deliver signals making it possible to determine the driving torque of the wheel, a rim, at least transmission spokes of which one end is attached to the torque lateral flange and another end is fastened to the rim, the method comprising the steps:
collecting signals from gauges or pairs of gauges,
comparing said signals,
if the difference between the value of at least one signal and the values of the other signals is greater than a given threshold, a tension differential in at least one transmission spoke in respect is diagnosed,
determining of the at least one transmission spoke having a tension differential with respect to the others,
modifying the tension of said at least one transmission spoke,
verifying the tension of the transmission spokes.
